(19) United States
(12) Patent Application Publication
(10) Pub. No.: US 2003/0107736 A1
(43) Pub. Date: Jun. 12, 2003

(54) Apparatus for inspecting pattern on semiconductor substrate

(75) Inventor: Hiroki Fujimoto, Kyoto (JP)

Correspondence Address: McDermott, Will & Emery, 600 13th Street, N.W., Washington, DC, 20005-3096, US

(73) Assignee: Dainippon Screen Mfg. Co., Ltd.

(21) Appl. No.: 10/309,244

(22) Filed: Dec. 4, 2002

(30) Foreign Application Priority Data
Dec. 7, 2001 (JP) P2001-373717
Dec. 7, 2001 (JP) P2001-373718

(51) Int. Cl. G01N 21/00; G06K 9/00

(52) U.S. Cl. 356/394; 356/237.2; 382/149

(57) ABSTRACT

In an inspection apparatus (1) for inspecting a pattern on a semiconductor substrate (9) which is processed by CMP, an optical head part (11) for acquiring a two-dimensional image of the pattern of the substrate (9) and a computer (13) for performing a computation are provided. In the computer (13), a reference image and an edge image of the reference image are prepared in advance and a differential image is obtained after performing a pattern matching between the acquired two-dimensional image and the reference image. In the differential image, an average value of absolute values of pixels is compared with a predetermined threshold value while an edge area indicated by the edge image is omitted, to detect whether there is a metal remaining film or not.

### BACKGROUND OF THE INVENTION

1. Field of the Invention

The present invention relates to a technique for inspecting a pattern on a semiconductor substrate.

2. Description of the Background Art

In recent, using a damascene process has been in the mainstream of a circuit formation process for a semiconductor substrate (hereinafter, referred to simply as “substrate”). In the damascene process, first, as shown in FIG. 1, a trench 911 for wiring is formed in a silicon oxide (Si0₂, hereinafter referred to as “oxide film”) 91 which is an insulator, and a metal for wiring is buried in the trench 911. As the metal for wiring, a wiring metal 92 for forming a wire and a barrier metal 93 for preventing ions in the wiring metal from diffusing in the oxide film are buried.

After burying the metal in the trench 911, as shown in FIG. 2, excess metal which crosses the interconnection path is removed to form a proper interconnection. As a method for removing the excess metal, in most cases, CMP (Chemical Mechanical Polishing) is used. By CMP, the excess metal is removed and the flatness of a substrate surface desired in a later photolithography process is obtained.

In the circuit formation process using the damascene process, it is necessary to detect whether the excess metal has been completely removed or not (to perform an endpoint detection in polishing). As the endpoint detection method, conventionally used is a method in which the estimated time of polishing end is obtained from the amount of grinding (polishing) per unit time and it is considered that the polishing should be ended at the estimated time of polishing end or a method in which the endpoint detection is performed from a change in torque of a polishing table.

In the methods of obtaining the endpoint from the estimated time of polishing end or the change in torque, however, it is impossible to check if there is a short circuit due to a remaining metal in a very small area on the substrate. Therefore, at the present time, some of the substrates which have been polished are picked as appropriate and an inspector (a person for inspection) checks if there is a remaining metal (hereinafter, referred to as “metal remaining film”) with a microscope, or after semiconductor chips (hereinafter, referred to simply as “chip”) are obtained by cutting, a tester is used to check if there is a short circuit.

In the case where an inspector checks if there is a metal remaining film with a microscope, the inspector has a need to observe a fine pattern for a long time and necessarily becomes increasingly fatigued. As a result, there is a possibility that there arises variation in quality of inspection.

The inspection using the tester is performed after chips are obtained by cutting the substrate, and therefore, the inspection result can not be efficiently used because the result is obtained after a considerably time from the polishing.

### SUMMARY OF THE INVENTION

It is an object of the present invention to stably perform a noncontact and nondestructive inspection of a pattern on a semiconductor substrate.

The present invention is intended for an apparatus for inspecting a pattern on a semiconductor substrate.

According to an aspect of the present invention, an apparatus for inspecting a pattern on a semiconductor substrate comprises a lighting part for emitting an illumination light to the semiconductor substrate, an image pickup device for acquiring data of a two-dimensional image of the pattern on the semiconductor substrate, an calculation part for performing calculations on the data of the two-dimensional image and a storage for storing data of a reference image, and in the apparatus, the calculation part establishes correspondence between pixels of the reference image and pixels of the two-dimensional image and obtains the difference in value of corresponding pixels between the reference image and the two-dimensional image to generate data of a differential image.

The present invention makes it possible to stably perform a noncontact and nondestructive inspection of the pattern on the semiconductor substrate.

Preferably, the calculation part obtains an index value indicating the degree of similarity between the reference image and the two-dimensional image on the basis of the differential image and compares the index value with a predetermined threshold value to acquire an inspection result, the storage stores data of an edge image which is obtained by extracting an edge from the reference image, and pixels in the differential image which correspond to an edge area indicated by the edge image are substantially omitted in obtaining the index value.

This increases inspection accuracy.

According to another aspect of the present invention, the apparatus for inspecting a pattern on a semiconductor substrate comprises a lighting part for emitting an illumination light to the semiconductor substrate, an image pickup device for acquiring data of a two-dimensional image of the pattern on the semiconductor substrate, an calculation part for performing calculations on the data of the two-dimensional image and a storage for storing data of a reference image, and in the apparatus, the calculation part acquires a first histogram and a second histogram of pixel values in corresponding areas of the reference image and the two-dimensional image, respectively, and obtains an index value indicating the degree of similarity between the first histogram and the second histogram.

The present invention makes it possible to stably perform a noncontact and nondestructive inspection of the pattern on the semiconductor substrate.

Preferably, the calculation part obtains an area of common portion of the first histogram and the second histogram as the index value, and further preferably, the calculation part equalizes an area of the first histogram and an area of the second histogram in obtaining the index value or the operation part changes a relatively positional relation between the first histogram and the second histogram so that the center pixel values of the first histogram and the second histogram coincide in obtaining the index value.

This increases inspection accuracy.

According to a preferred embodiment, the lighting part selects one of a plurality of kinds of illumination lights to be emitted to the semiconductor substrate. It is thereby possible to acquire a two-dimensional image having high contrast according to characteristics of the semiconductor substrate.

According to another preferred embodiment, the operation part obtains correlation between the reference image and the two-dimensional image by substantially rotating the two-dimensional image at arbitrary angles relatively to the reference image in establishing correspondence between the pixels of the reference image and the pixels of the two-dimensional image. It is thereby possible to perform the inspection regardless of directions of the substrate.

The present invention is also directed to a method and a computer-readable medium for inspecting a pattern on a semiconductor substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1 and 2 are views showing a state where a wiring pattern is formed on a substrate;

FIG. 3 is a view showing an overall structure of an inspection apparatus;

FIG. 4 is a diagram showing a construction of a computer;

FIG. 5 is a block diagram showing a functional structure of the computer;

FIG. 6 is a flowchart showing an operation flow of recipe registration;

FIG. 7 is a view illustrating a plurality of inspection portions;

FIG. 8 is a view illustrating positions of object chips to be inspected on the substrate;

FIG. 9 is a view illustrating a reference image;

FIG. 10 is a view illustrating an edge image;

FIG. 11 is a view illustrating an operator;

FIGS. 12 and 13 are flowcharts showing a flow of inspecting operation;

FIG. 14 is a view illustrating an acquired image;

FIG. 15 is a view illustrating superimposition of the reference image and the acquired image;

FIG. 16 is a view illustrating a differential image;

FIG. 17 is a block diagram showing a functional structure of the computer in another case of operation;

FIG. 18 is a flowchart showing an operation flow of recipe registration;

FIG. 19 is a view illustrating a plurality of inspection portions;

FIG. 20 is a view illustrating a reference image;

FIGS. 21 and 22 are flowcharts showing a flow of inspecting operation;

FIG. 23 is a flowchart showing a flow ofjudgment operation;

FIG. 24 is a graph illustrating a reference histogram;

FIG. 25 is a graph illustrating an object histogram;

FIG. 26 is a graph showing superimposition of the reference histogram and the object histogram;

FIG. 27 is a graph showing another example of obtaining an index value;

FIG. 28 is a view showing a path range in a dynamic programming; and

FIG. 29 is a view showing a method for obtaining a cumulative distance in the dynamic programming.

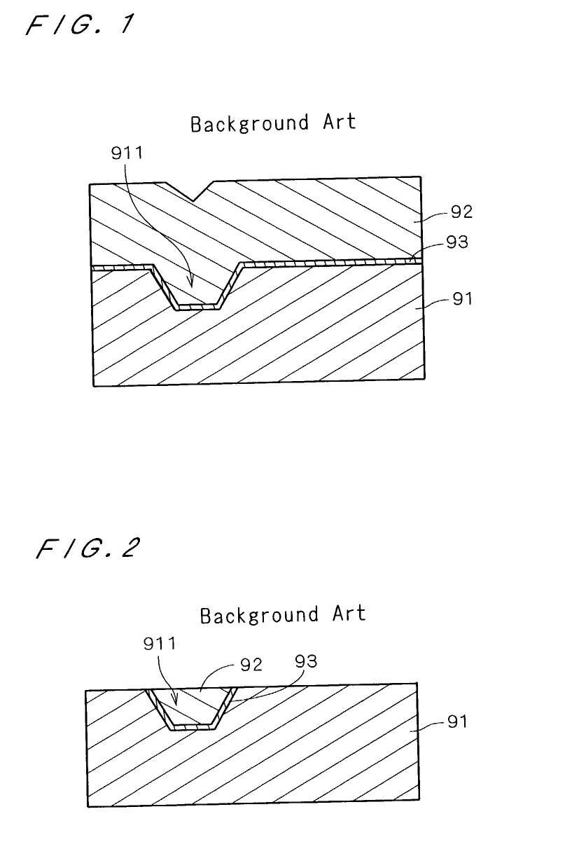

### DESCRIPTION OF THE PREFERRED EMBODIMENTS

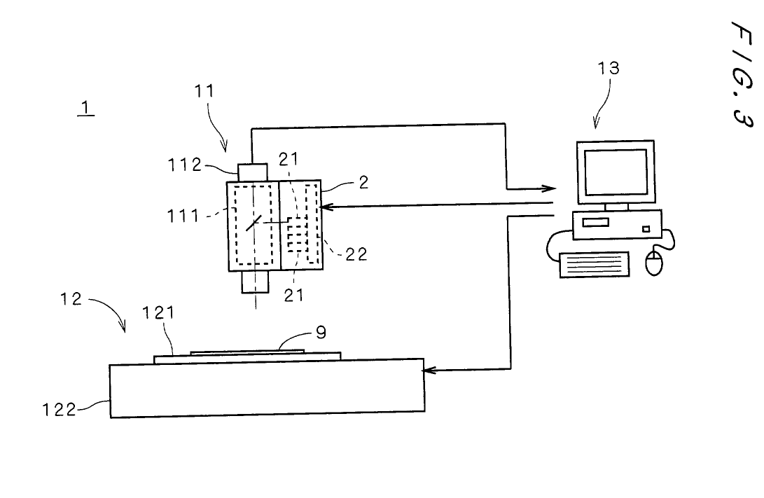

FIG. 3 is a view showing an overall structure of a semiconductor substrate inspection apparatus (hereinafter, referred to simply as “inspection apparatus”) 1 for inspecting a semiconductor substrate 9 on which a wiring pattern is formed by a damascene process.

The inspection apparatus 1 has an optical head part 11 for acquiring data of a two-dimensional image by imaging the substrate 9, a stage part 12 for supporting the substrate 9 and transferring the substrate 9 relatively to the optical head part 11 and a computer 13 connected to the optical head part 11 and the stage part 12.

The optical head part 11 has an optical system 111 which guides an illumination light to the substrate 9 and receives light from the substrate 9, an image pickup device 112 for converting an image of the substrate 9 formed by the optical system 111 into an electrical signal and a light source unit 2 which selects one of a plurality of kinds of illumination lights and emits the selected one to the optical system 111, thereby irradiating the substrate 9 with the illumination light.

The light source unit 2 has a plurality of light sources 21 corresponding to the kinds of illumination lights and a light source driving part 22, and the light source driving part 22 transfers a plurality of light sources 21 to change the illumination light. As the light sources 21, a plurality of light sources which emit illumination lights according to characteristics of a surface of the substrate 9 are prepared, at least including a light source which emits a monochromatic light in order to increase visibility of a multilayer film. Naturally, a plurality of light sources 21 may include ones which emit a white light and a light with color of incandescent lamp.

The stage part 12 has a stage 121 for supporting the substrate 9 and a stage driving part 122 for transferring the stage 121 in a horizontal plane. Further, the stage driving part 122 may additionally have a mechanism for rotating the stage 121 in the horizontal plane.

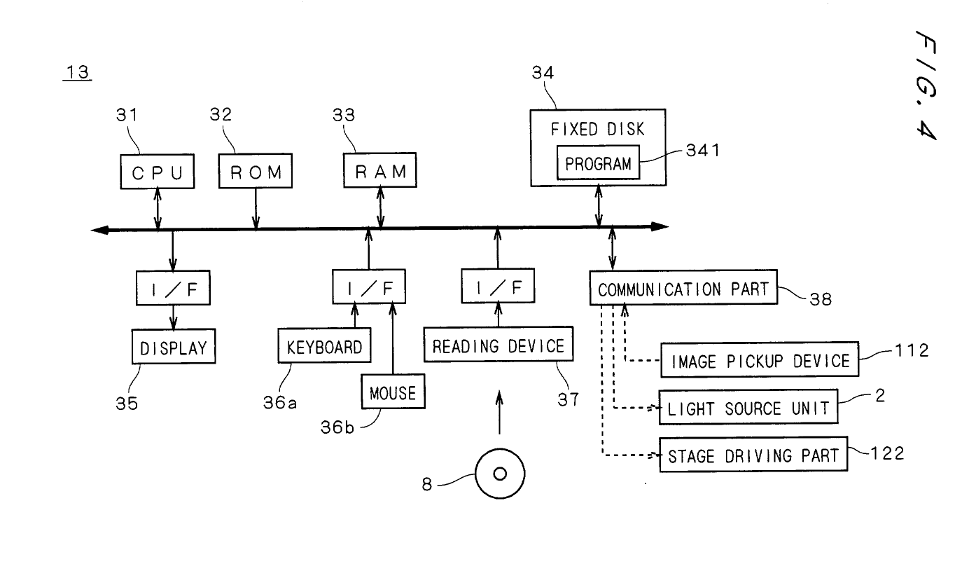

The computer 13 has a general computer system, as shown in FIG. 4, in which a CPU 31 for performing various calculations, a ROM 32 for storing a basic program and a RAM 33 for storing various information which are connected to a bus line. To the bus line, a fixed disk (hard disk) 34 for storing information, a display 35 for displaying various information, a keyboard 36a and a mouse 36b which receive an input from a user, a reading device 37 for reading information out from computer-readable recording media 8 such an optical disk, a magnetic disk or a magneto-optic disk, and a communication part 38 for making communication with the image pickup device 112, the light source unit 2 and the stage driving part 122 are further connected, for example, through an interface (I/F) as appropriate.

In the computer 13, a program 341 is read out from the recording medium 8 through the reading device 37 in advance and stored in the fixed disk 34. Then, the program 341 is copied in the RAM 33 and the CPU 31 performs calculations according to the program 341 in the RAM 33 (that is, the computer 13 executes the program), by which the computer 13 controls the various constituents to perform an inspection. The recording medium 8 may be another kinds of program products, such as a memory card or a fixed disk, only if the media contain a computer-readable program.

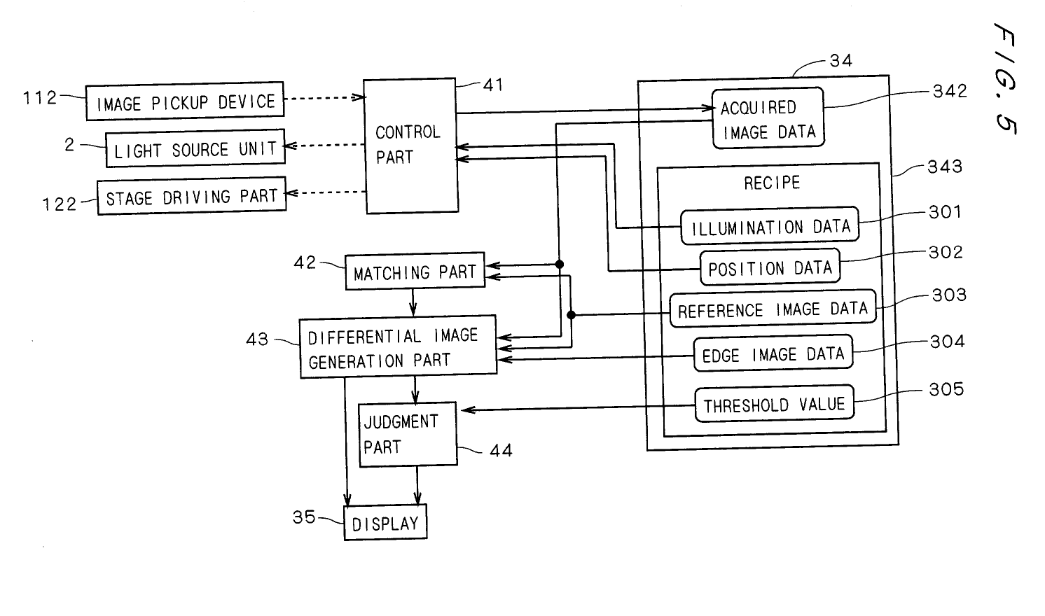

FIG. 5 is a block diagram showing a structure of functions implemented by the CPU 31, the ROM 32, the RAM 33 and the like in an operation by the CPU 31 according to the program 341. In FIG. 5, a control part 41, a matching part 42, a differential image generation part 43 and a judgment part 44 are functions implemented by the CPU 31 and the like. These functions may be implemented by dedicated electric circuits, or may be partially implemented by the electric circuits.

The control part 41 receives an image signal from the image pickup device 112 and stores the signal in the fixed disk 34 as acquired image data 342, and controls operations of the light source unit 2 and the stage driving part 122. The matching part 42 performs a pattern matching between an image acquired by the image pickup device 112 (hereinafter, referred to as “acquired image”) and a reference image discussed later. The differential image generation part 43 obtains a differential image of the acquired image and the reference image. The judgment part 44 judges whether there is a metal remaining film on the substrate 9 or not.

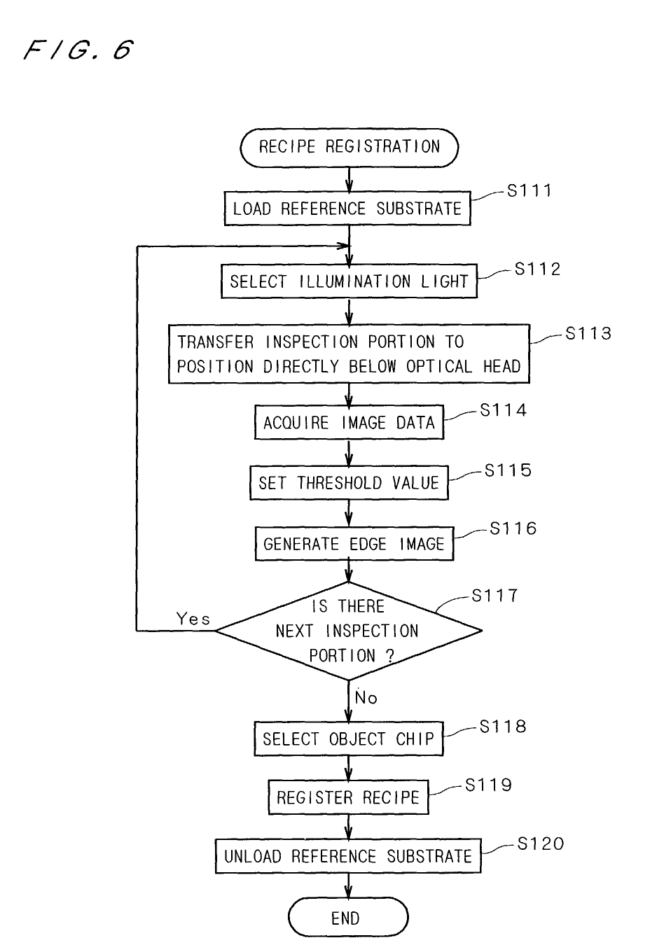

In the inspection apparatus 1, a preparatory operation for inspection is performed before the actual inspecting operation. FIG. 6 is a flowchart showing a flow of registration of recipe which is a data set including various data used for the inspection, as the preparatory operation.

In the recipe registration, first, a reference substrate which is processed by appropriate CMP in advance is loaded on the stage part 12 (Step S111). Next, the illumination light is selected according to the kind of film of an object portion to be inspected (inspection portion) (Step S112). In other words, the user selects the illumination light by manipulating the keyboard 36a or the mouse 36b, and according to the user's manipulation, the control part 41 drives the light source driving part 22 of the light source unit 2 and lights the selected light source 21.

The selected illumination light is one that allows acquisition of an image having high contrast on the basis of characteristics of a metal, a thin film or the like which are to be detected as defects, and preferably a monochromatic light is selected. It is thereby possible to acquire an image having high S/N ratio in accordance with the characteristics of the inspection portion.

Subsequently, the stage 121 moves on the basis of the user's manipulation and the inspection portion of a specified chip on the reference substrate is thereby transferred to a position directly below the optical head part 11 (Step S113). After that, the image pickup device 112 performs an image pickup, and data of the reference image which represents a reference pattern is stored in the fixed disk 34 as reference image data 303 (see FIG. 5) (Step S114).

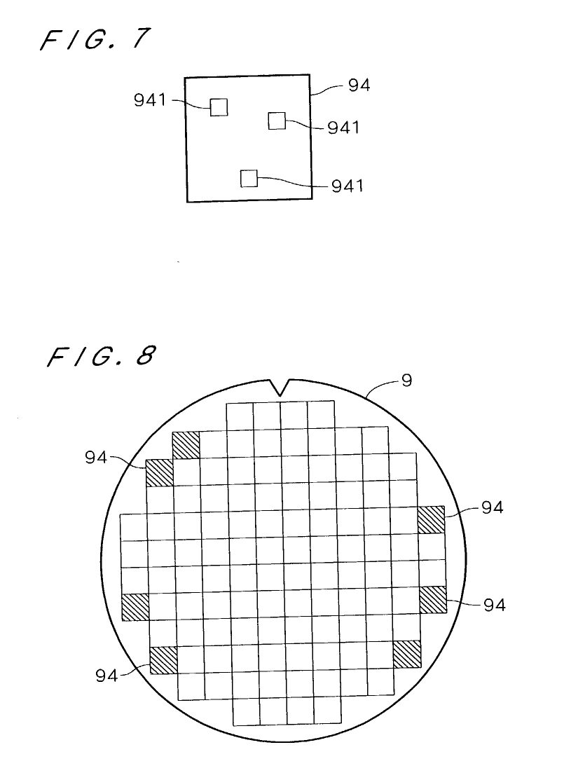

FIG. 7 is a view illustrating a plurality of inspection portions 941 in an area corresponding to one chip 94 on the substrate 9, and FIG. 8 is a view illustrating positions of some (hatched) of the chips 94 on the substrate 9 which are to be inspected. As shown in FIG. 7, only limited areas in one chip 94 are to be imaged in one image pickup. In one chip 94, portions which are empirically grasped to probably have metal remaining films in advance on the basis of the state of underlying layer or the wiring pattern are determined as inspection portions 941.

Further, as shown in FIG. 8, the positions of the chips 94 on one substrate 9 which are likely to have the metal remaining films are also empirically found from the characteristics of the CMP. Then, in the inspecting operation discussed later, the respective inspection portions 941 in all the chips 94 to be inspected are objects to be inspected. In the recipe registration, various conditions are acquired for only one chip 94. In the inspecting operation discussed later, the recipe is applied to all the chips 94.

When acquisition of the reference image data 303 is completed, the user sets a threshold value for judgment on whether the pattern on the substrate 9 is good or not (Step S115). The user may empirically set the threshold value or may use a faulty substrate which is prepared separately.

In an operation using the faulty substrate, though not shown, first, image data of the inspection portion 941 on the faulty substrate is acquired and a differential image of the reference image and the image of the faulty substrate is obtained. Then, a value is obtained by the same method as an index value (a value used for comparison with the threshold value, see the inspecting operation in detail) discussed later, and the user sets the threshold value on the basis of the obtained value.

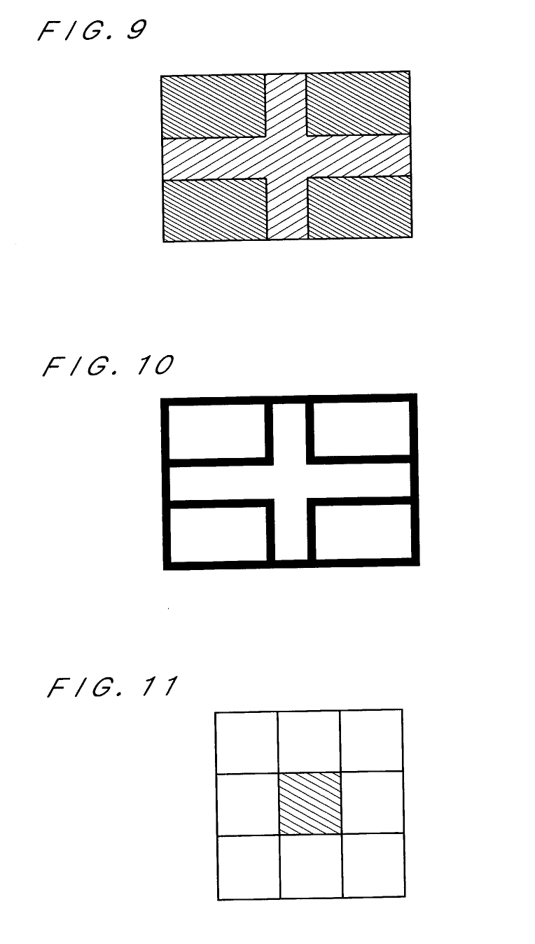

Next, an edge image is generated by extracting an edge of the reference image as a line having a constant width (Step S116). In a case of the reference image shown in FIG. 9, for example, an edge image shown in FIG. 10 is generated and stored in the fixed disk 34 as edge image data 304 (see FIG. 5). In generation of the edge image, peripheral portions of the image are also regarded as the edge.

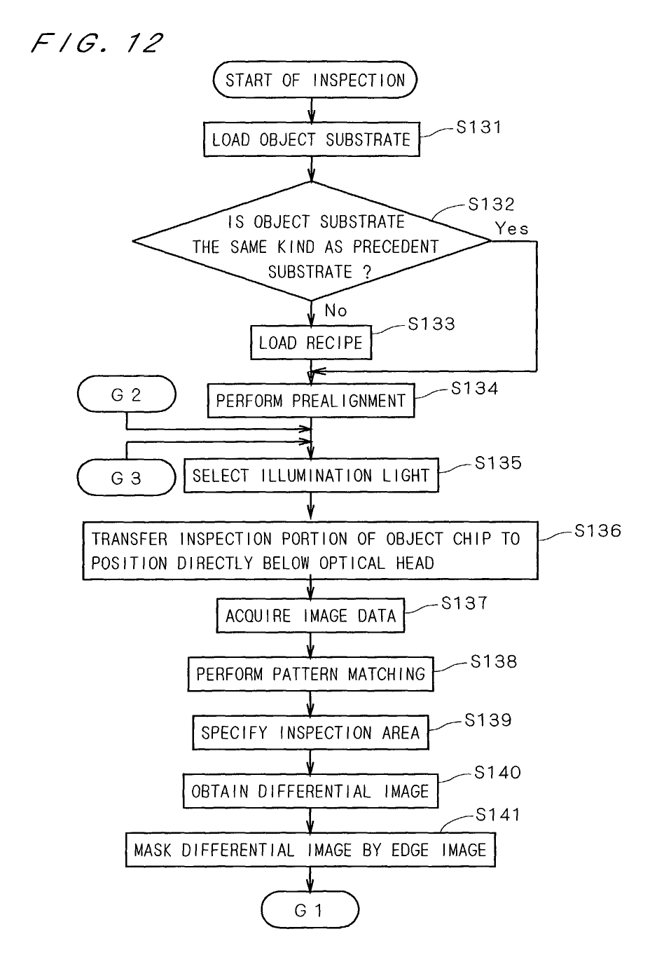

In generation of the edge image, first, an operator to be superimposed on the reference image is prepared. FIG. 11 is a view illustrating the operator, and the operator has a size in which pixels in odd numbers are arranged both in rows and columns. Then, the absolute values of differences between a value of the central pixel (hatched in FIG. 11) of the operator superimposed on the reference image and values of the other pixels are added, and when the added value is over a predetermined value, a value of the corresponding pixel in the edge image is set to 1 and when the added value is equal to or less than the predetermined value, the pixel value is set to 0. Since the edge detection by this method has no directivity, it can be performed more easily than a usual edge detection by directions.

Naturally, a plurality of operators having different sizes may be applied to one reference image, and in this case, the above added value is divided by the number of pixels of the operator in order to eliminate the effect of the size of the operator. By applying a plurality of operators having different sizes to the reference image, it is possible to generate an edge image which allows an appropriate judgment on various patterns in the inspection.

When Steps S112 to S116 are completed on one inspection portion 941, Steps S112 to S116 are repeated on another inspection portion 941 in the same chip 94 (Step S117). When Steps S112 to S116 are completed on all the inspection portions 941 in one chip 94, positions of chips 94 to be inspected (hereinafter, referred to as “object chip”) on the substrate 9 are selected (Step S118). For example, the chips 94 which are hatched in FIG. 8 indicate the positions of the object chips.

After that, the information on the above operation is registered in the fixed disk 34 as a recipe 343 as shown in FIG. 5 (in a data format of the recipe 343) (Step S119). Illumination data 301 of FIG. 5 indicates the kind of illumination light selected for each inspection portion 941 in Step S112, position data 302 indicates the positions and the number of the inspection portions 941 specified in Step S113, the reference image data 303 is image data of each inspection portion 941 which is acquired in Step S114, the edge image data 304 is image data of each inspection portion 941 which is generated in Step S116 and a threshold value 305 indicates a value which is set for each inspection portion 941 in Step S115.

Finally, the reference substrate is unloaded from the stage 121 and the operation for recipe registration is completed (Step S120).

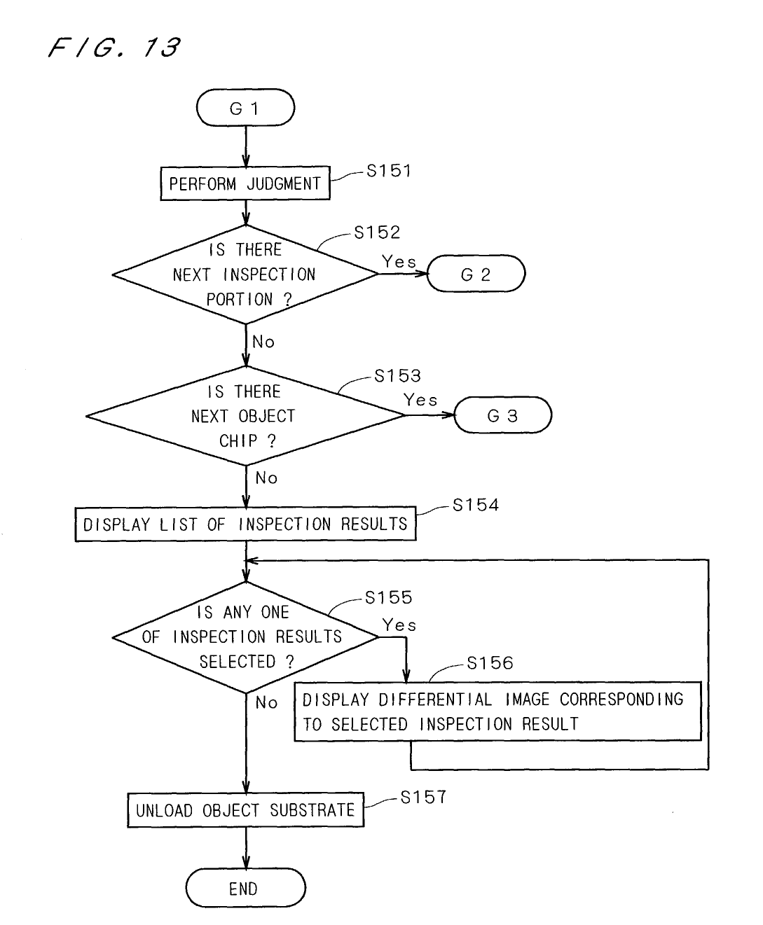

FIGS. 12 and 13 are flowcharts showing a flow of an operation of the inspection apparatus 1 in the inspection performed on one substrate (hereinafter, referred to as “object substrate”) 9. The inspecting operation will be discussed below along FIGS. 12 and 13, with reference to FIGS. 3 to 5.

First, the object substrate 9 is loaded on the stage 121 of the stage part 12 (Step S131). The object substrate 9 may be automatically loaded from a CMP apparatus or a facility line including the CMP apparatus, or the user may put the substrate 9 onto the stage 121 as appropriate.

In the inspection apparatus 1, the computer 13 checks if the loaded object substrate 9 is the same kind as the precedently-inspected substrate 9 (Step S132), and when not the same, the recipe 343 according to the kind of object substrate 9 is loaded (Step S133). Specifically, the recipe 343 is read out from the fixed disk 34 and stored in the RAM 33, thereby being accessible by the CPU 31. The loading of the recipe 343 may be an operation of specifying one recipe 343 in the fixed disk 34. FIG. 5 shows a flow of various data on the recipe 343 in the fixed disk 34, for convenience of illustration.

Next, the image pickup device 112 performs an image pickup with low magnification according to the control of the control part 41, and the CPU 31 compares the acquired image with a pattern (in a notch shape or typical pattern) which is prepared in advance to detect approximate position and direction of the object substrate 9 on the stage 121. The control part 41 controls the stage driving part 122 as a prealignment on the basis of the detection result so that the first object chip 94 of the object substrate 9 can be positioned approximately below the optical head part 11 (Step S134).

When the prealignment is completed, the control part 41 controls the light source driving part 22 with reference to the illumination data 301 of the recipe 343 to position the light source 21 which emits an illumination light suitable for the inspection portion 941 at a light guiding position to the optical system 111 and light the selected light source 21. The selected illumination light is thereby emitted to the object substrate 9 through the optical system 111 (Step S135).

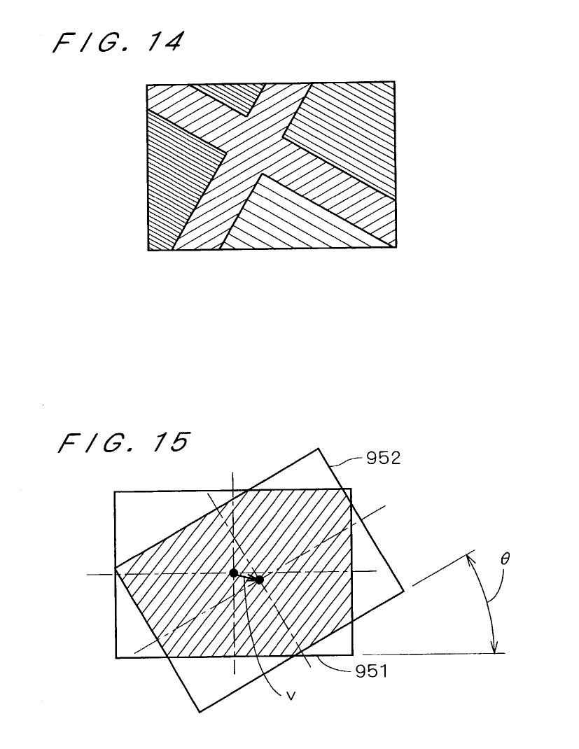

Further, the control part 41 transfers the stage 121 with reference to the position data 302 of the recipe 343 so that the first inspection portion 941 of the object chip 94 to be first inspected can be positioned directly below the optical head part 11 (Step S136). Then, the image pickup device 112 acquires an image of the inspection portion 941 through the optical system 111 as a signal and the image signal is converted into digital data in a circuit of the image pickup device 112 or the control part 41 and stored in the fixed disk 34 as the acquired image data 342 (Step S137). FIG. 14 is a view illustrating the image acquired correspondingly to the reference image of FIG. 9.

The acquired image data 342 and the reference image data 303 are transmitted to the matching part 42 and a positional relation between the acquired image and the reference image is examined in more detail by, for example, pattern matching of normalized correlation method (Step S138). Specifically, the acquired image is superimposed on the reference image in various positions and directions, and respective vectors having all the pixel values in overlapping areas of these images as elements are obtained and an inner product of two vectors corresponding to these images is calculated. Then, the position and direction of the acquired image at the maximum inner product is obtained.

In the pattern matching, the correlation (inner product) between the reference image and the acquired image is obtained while the acquired image is substantially rotated at arbitrary angles relatively to the reference image. The correspondence of these images can be thereby obtained regardless of the direction of the substrate 9. When the substrate 9 is automatically loaded from an apparatus which processes the substrate 9 while rotating it, such as the CMP apparatus, the substrate 9 immediately after loading points in an arbitrary direction. Even in such a case, the inspection apparatus 1 can perform the pattern matching without rotating the stage 121.

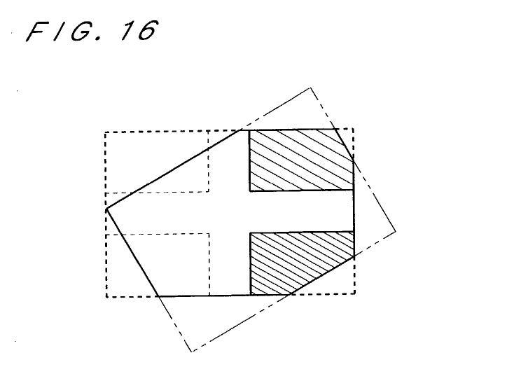

When it turns out that correspondence between the reference image 951 and the acquired image 952 can be established by the pattern matching with the reference image 951 parallelly transferred by a transfer vector v and rotated about a predetermined origin point by θ degrees as shown in FIG. 15, it becomes possible to convert a position vector p of one pixel in a coordinate system of the acquired image 952 into a position vector q of the corresponding pixel in a coordinate system of the reference image 951 by the computation of the following equation 1 (Eq. 1) in the overlapping area of the reference image 951 and the acquired image 952 (hatched area in FIG. 15). In Eq. 1, A(−θ) is a matrix where the position vector is rotated by (−θ) degrees.

q=A(−θ)·(p−v) (Eq. 1)

For a pixel in the acquired image 952 which has no corresponding pixel in the reference image 951, a value indicating that it is not an object of computation, such as a negative pixel value, is set. An area of the inspection portion 941 which is to be actually computed (hereinafter, referred to as “inspection area”) is thereby specified in the acquired image 952 (Step S139).

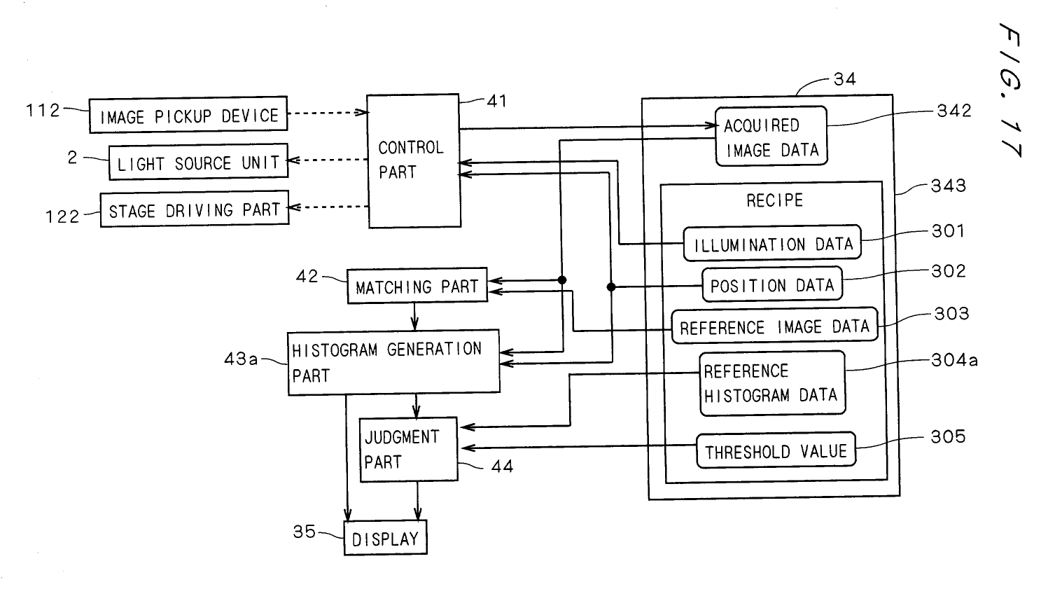

The acquired image data 342, the reference image data 303, the transfer vector v and the rotating angle θ which are used for overlapping of these images and the inspection area are inputted to the differential image generation part 43, to generate data of the differential image having the difference of corresponding pixel values of these images as pixel values with respect to the overlapping area of these images (Step S140). FIG. 16 is a view illustrating the differential image obtained from the reference image of FIG. 9 and the acquired image of FIG. 14.

The differential image data and the edge image data 304 of the recipe 343 are transmitted to the judgment part 44, and the differential image is masked by the edge image (Step S141). For example, a value of a pixel of the differential image corresponding to the pixel of the edge image having a value of 1 (i.e., the pixel of the edge area) is a special value to be omitted in the computation for judgment. Then, an average value of absolute values of the pixels other than the pixels to be omitted in the differential image is obtained, and the average value is compared with the threshold value 305 in the recipe 343.

When the average value is not less than the threshold value 305, it is judged that there is a metal remaining film, and when the average value is less than the threshold value 305, it is judged that there is no metal remaining film (Step S151). Thus, the inspection apparatus 1 uses the above average value as an index value indicating the degree of similarity between the reference image and the acquired image.

The matching between the reference image and the acquired image is usually accompanied by an error of at least one pixel or less. In other words, depending on where the edge of the pattern is positioned with respect to one pixel, the pixel value corresponding to the edge varies. Further, there arises an error also in quantization of the pixel value. Therefore, when the differential image is obtained after the pattern matching, the absolute value of the pixel corresponding to the edge of the pattern becomes large. Then, the judgment part 44 performs the judgment with the pixels corresponding to the edge substantially omitted by using the edge image, to thereby increase the inspection accuracy.

When the inspection of one inspection portion 941 is completed, whether there is any uninspected inspection portion 941 or not in the object chip 94 is checked (Step S152), and when there is an uninspected inspection portion 941, Steps S135 to S141 and Step S151 are repeated. Further, when the inspections of all the inspection portions 941 in one object chip 94 are completed, whether there is any uninspected object chip 94 or not is checked (Step S153), and when there is an uninspected object chip 94, Steps S135 to S141 and Step S151 are repeated on all the inspection portions 941 of another object chip 94.

When the inspections of all the inspection portions 941 of all the object chips 94 are completed, a list of the inspection results is displayed on the display 35 (Step S154). The user using the inspection apparatus 1 can select any one of the inspection portions 941 which are judged to have metal remaining films by using the keyboard 36aor the mouse 36b, and through the selection of one inspection portion 941 by the user, the differential image (or acquired image) corresponding to the inspection result is displayed on the display 35 (Steps S155 and S156). Through this operation, the user can accurately grasp the state of metal remaining films as a two-dimensional distribution.

When the user grasps the inspection results, the object substrate 9 is unloaded from the stage 121 (Step S157). The object substrate 9 may be automatically loaded and unloaded from/to a substrate processing line, and in this case the inspection apparatus 1 lies “in-line”. The inspection results are transmitted to other apparatuses for processing the chips 94 which are obtained from the unloaded object substrate 9 or inspecting whether the chips 94 are good or not, and used therein. This improves efficiency of processing or inspection in other apparatuses.

The CMP may be performed again on the object substrate 9, depending on the inspection result. This improves the yield of the chips 94 obtained from the object substrate 9 which is processed by insufficient CMP.

Thus, since the pattern inspection of the substrate 9 can be automatically performed and the faulty portions can be accurately grasped as the two-dimensional image in the inspection apparatus 1, it is possible to reduce the load of the user and stably perform the noncontact and nondestructive inspection of a pattern on a semiconductor substrate.

Next, another example of operation of the inspection apparatus 1 will be discussed. The constitution of the inspection apparatus 1 is the same as shown in FIGS. 3 and 4.

FIG. 17 is a block diagram showing a structure of functions implemented by the CPU 31, the ROM 32, the RAM 33 and the like in an operation by the CPU 31 according to the program 341. FIG. 17 shows a structure in which a histogram generation part 43a for obtaining a histogram on frequency of each pixel value from the acquired image is provided instead of the differential image generation part 43. These functions may be implemented by dedicated electric circuits, or may be partially implemented by the electric circuits.

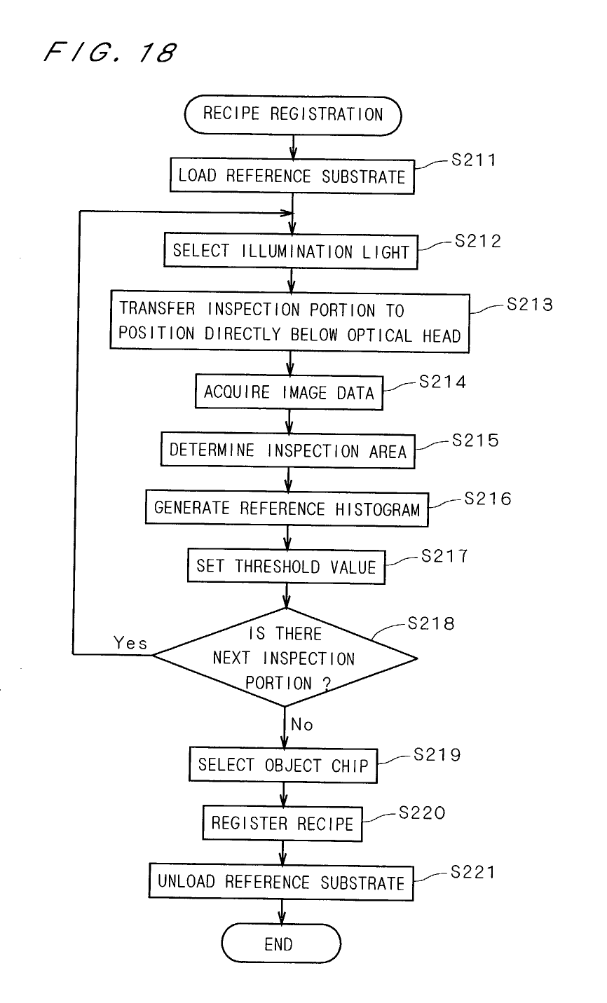

FIG. 18 is a flowchart showing a flow of registration of recipe which is a data set including various data used for the inspection, as the preparatory operation.

In the recipe registration, first, like in FIG. 6, the reference substrate is loaded on the stage part 12 (Step S211); and the illumination light is selected according to the kind of film of an inspection portion (Step S212).

Subsequently, the inspection portion in a specified chip on the reference substrate is transferred to a position directly below the optical head part 11 (Step S213), the image pickup device 112 performs an image pickup, and data of the reference image which represents a reference pattern is stored in the fixed disk 34 as the reference image data 303 (see FIG. 17) (Step S214).

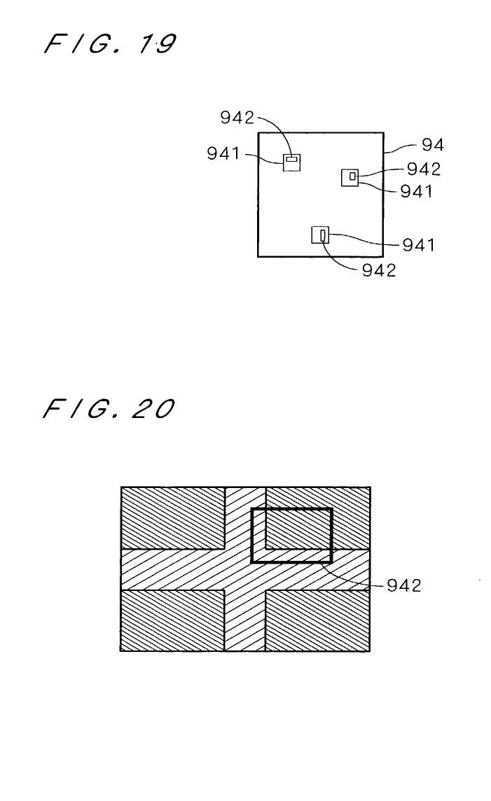

FIG. 19 is a view illustrating a plurality of inspection portions 941 in an area corresponding to one chip 94 on the substrate 9, and only specified ones of the chips 94 on the substrate 9 are objects to be inspected as shown in FIG. 8. As shown in FIG. 19, only limited areas in one chip 94 are to be imaged in one image pickup. In one chip 94, portions which are empirically grasped to probably have metal remaining films in advance on the basis of the state of underlying layer or the wiring pattern are determined as inspection areas 942 in the inspection portions 941 (Step S215). FIG. 20 is a view illustrating the inspection area 942 in the reference image.

Next, a reference histogram is generated on the basis of the pixel values of the inspection area 942 (Step S216). The reference histogram is normalized so that the area thereof is 1, and assuming that the frequency (i.e., the number of pixels) of the pixel value i in the inspection area 942 is H₀[i], the frequency Nₒ[i] of the reference histogram is obtained by the computation of the following equation 2 (Eq. 2). Data of the obtained reference histogram is stored in the fixed disk 34 as reference histogram data 304a (see FIG. 17).

$${N}_{0} [ i ] = \frac{{H}_{0} [ i ]}{\sum {H}_{0} [ i ]} \qquad ( Eq . 2 )$$

When the reference histogram is acquired, the user sets a threshold value for judgment on whether the pattern on the substrate 9 is good or not (Step S217). The user may empirically set the threshold value or may use a faulty substrate which is prepared separately.

In an operation using the faulty substrate, though not shown, first, image data of the inspection area 942 on the faulty substrate is acquired and a normalized histogram of the inspection area 942 is obtained. Then, a value is obtained by the same method as an index value (a value used for comparison with the threshold value, see the inspecting operation in detail) discussed later, and the user sets the threshold value on the basis of the obtained value.

When Steps S212 to S217 are completed on one inspection portion 941, Steps S212 to S217 are repeated on another inspection portion 941 in the same chip 94 (Step S218). When Steps S212 to S217 are completed on all the inspection portions 941 in one chip 94, positions of chips 94 to be inspected (hereinafter, referred to as “object chip”) on the substrate 9 are selected (Step S219). For example, the chips 94 which are hatched in FIG. 8 indicate the positions of the object chip.

After that, the information on the above operation is registered in the fixed disk 34 as the recipe 343 as shown in FIG. 17 (in a data format of the recipe 343) (Step S220). Illumination data 301 of FIG. 17 indicates the kind of illumination light selected for each inspection portion 941 in Step S212, position data 302 indicates the positions and the number of the inspection portions 941 specified in Step S213 and the range of the inspection area 942 which is set in Step S215, the reference image data 303 is image data of each inspection portion 941 which is acquired in Step S214, the reference histogram data 304a is image data of each inspection area 942 which is generated in Step S216 and the threshold value 305 indicates a value which is set for each inspection portion 941 in Step S217.

Finally, the reference substrate is unloaded from the stage 121 and the operation for recipe registration is completed (Step S221).

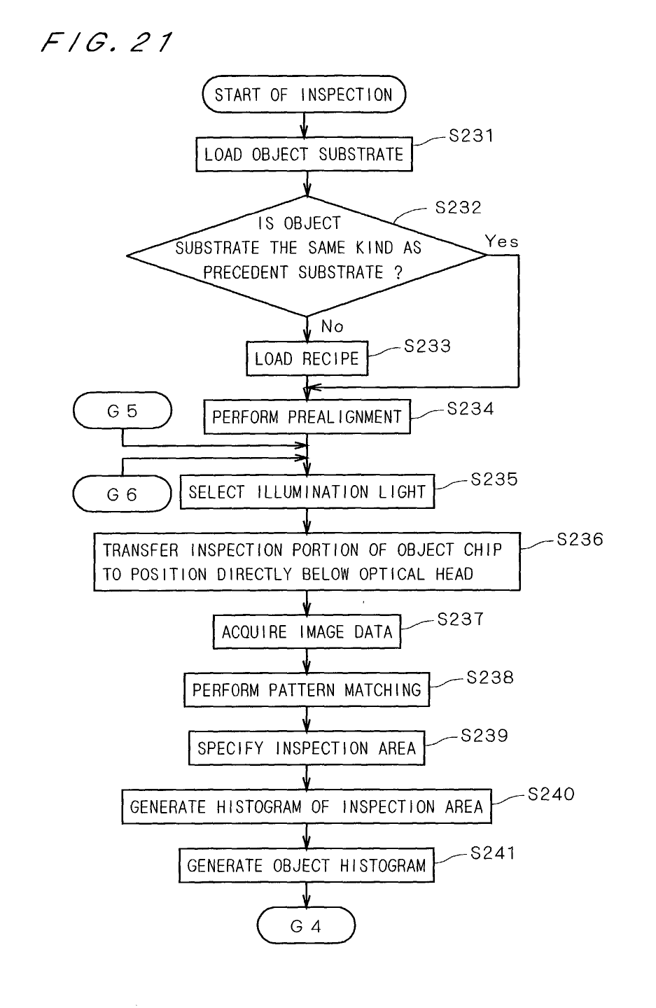

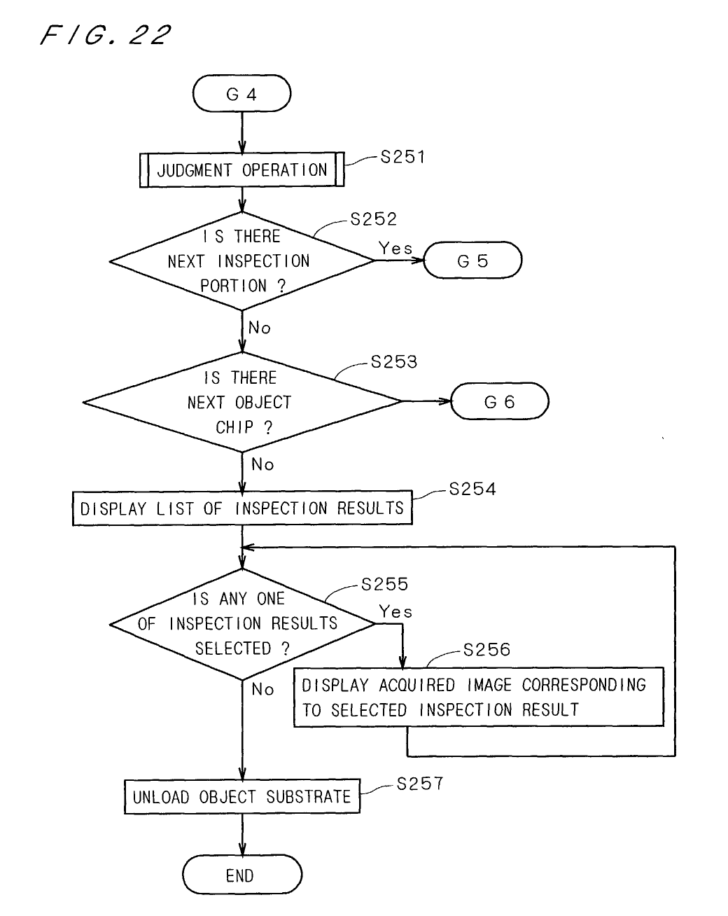

FIGS. 21 and 22 are flowcharts showing a flow of an operation of the inspection apparatus 1 in the inspection performed on one substrate (hereinafter, referred to as “object substrate”) 9. The inspecting operation will be discussed below along FIGS. 21 and 22, with reference to FIGS. 3, 4 and 17.

The first half of the inspecting operation is the same as that shown in FIG. 12. First, the object substrate 9 is loaded on the stage 121 of the stage part 12 (Step S231), and the computer 13 checks if the loaded object substrate 9 is the same kind as the precedently-inspected substrate 9 (Step S232), and when not the same, the recipe 343 according to the kind of object substrate 9 is loaded (Step S233).

Next, the image pickup device 112 performs an image pickup with low magnification according to the control of the control part 41 to detect approximate position and direction of the object substrate 9 on the stage 121, and the control part 41 controls the stage driving part 122 as a prealignment so that the first object chip 94 of the object substrate 9 can be positioned approximately below the optical head part 11 (Step S234). Then, the control part 41 controls the light source driving part 22 with reference to the illumination data 301 of the recipe 343 and the selected illumination light is thereby emitted to the object substrate 9 through the optical system 111 (Step S235).

Further, the control part 41 transfers the stage 121 with reference to the position data 302 of the recipe 343 so that the first inspection portion 941 of the object chip 94 to be first inspected can be positioned directly below the optical head part 11 (Step S236). Then, the image pickup device 112 acquires an image of the inspection portion 941 through the optical system 111 as a signal and the image signal is converted into digital data in a circuit of the image pickup device 112 or the control part 41 and stored in the fixed disk 34 as the acquired image data 342 (Step S237).

The acquired image data 342 and the reference image data 303 are transmitted to the matching part 42 and a positional relation between the acquired image and the reference image is examined in more detail by the same method as in the case of FIG. 12 (Step S238).

In the pattern matching, the correlation (inner product) between the reference image and the acquired image is obtained while the acquired image is substantially rotated at arbitrary angles relatively to the reference image. The correspondence of these images can be thereby obtained regardless of the direction of the substrate 9. When the substrate 9 is automatically loaded from an apparatus which processes the substrate 9 while rotating it, such as the CMP apparatus, the substrate 9 immediately after loading points in an arbitrary direction. Even in such a case, the inspection apparatus 1 can perform the pattern matching without rotating the stage 121. Further, the pattern matching can increase the accuracy ofjudgment discussed later.

When it turns out that correspondence between the reference image 951 and the acquired image 952 can be established by the pattern matching with the reference image 951 parallelly transferred by the transfer vector v and rotated about a predetermined origin point by θ degrees, it becomes possible to convert the position vector p of one pixel in a coordinate system of the acquired image 952 into the position vector q of the corresponding pixel in the coordinate system of the reference image 951 by the computation of Eq. 1 as shown earlier in the overlapping area of the reference image 951 and the acquired image 952 (see FIG. 15).

The acquired image data 342, the transfer vector v, the rotating angle θ and the position data 302 indicating the inspection area are inputted to the histogram generation part 43a, to specify the inspection area in the acquired image corresponding to the inspection area in the reference image (Step S239). The histogram generation part 43a generates a histogram indicating the frequency of each pixel value of the inspection area in the acquired image (Step S240), and normalizes the histogram to generate an object histogram (Step S241). The object histogram is generated by the same method as the reference histogram. Specifically, assuming that the frequency of the pixel value i in the inspection area is H₁[i], the frequency N₁[i] of the object histogram is obtained by the computation the following equation 3 (Eq. 3).

$${N}_{1} [ i ] = \frac{{H}_{1} [ i ]}{\sum {H}_{1} [ i ]} \qquad ( Eq . 3 )$$

Since the area of the object histogram becomes equal to the area of the reference histogram through computation of Eq. 3, Step S241 is a step for modifying the frequency of the object histogram so that the area of the histogram of the inspection area should become equal to the area of the reference histogram.

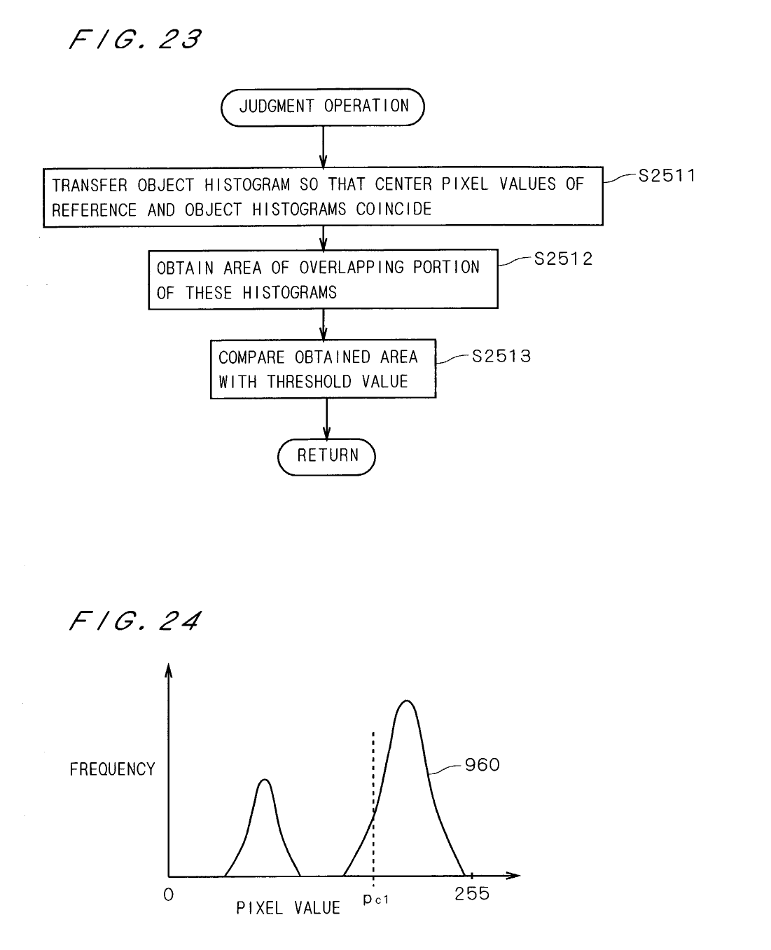

Next, the judgment part 44 reads the reference histogram data 304a in the recipe 343 to acquire the reference histogram and acquires the object histogram from the histogram generation part 43a. Then, the judgment part 44 performs the judgment on the pattern in the inspection area by using these histograms (Step S251). FIG. 23 is a flowchart showing a flow of judging operation by the judgment part 44.

The judgment part 44 first performs a transfer of the object histogram so that the center pixel values of the reference histogram and the object histogram should coincide with each other (which corresponds to lightness correction of the inspection area) (Step S2511). The center pixel values of the histograms may be any one only if it indicates an approximate center, and for example, the barycenter or the intermediate value of the histogram can be used as the center. Even if the brightness of the light source 21 is changed through the transfer of the object histogram, an accurate judgment can be achieved. Further, the reference histogram may be transferred only if the relative positional relation between the reference histogram and the object histogram is changed.

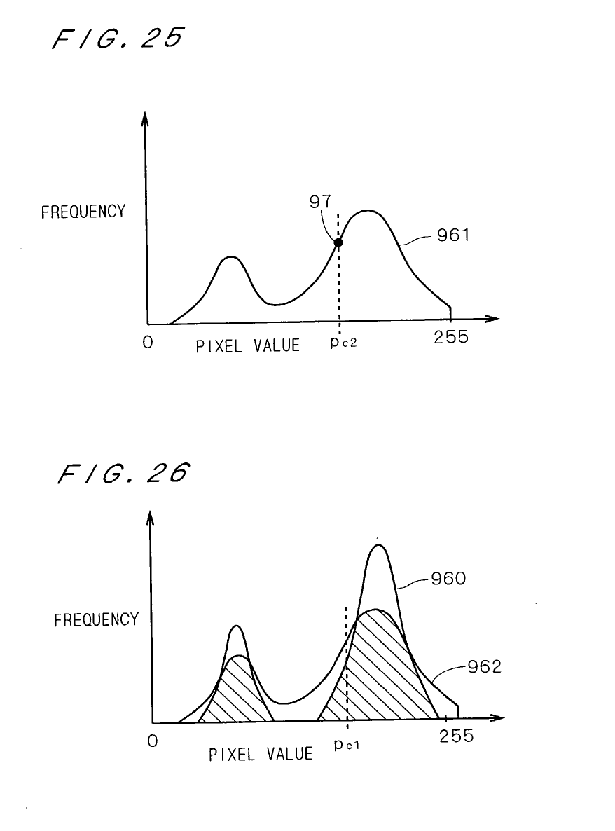

FIG. 24 is a graph illustrating a reference histogram 960, and FIG. 25 is a graph illustrating an object histogram 961. Assuming that a pixel value corresponding to the intermediate value of the reference histogram 960 is indicated by p_{c1} in FIG. 24 and a pixel value corresponding to the intermediate value of the object histogram 961 is indicated by p_{c2} in FIG. 25, the whole object histogram 961 is transferred in a horizontal direction (the axial direction of pixel value) so that a pixel value corresponding to a point 97 in FIG. 25 should be the pixel value p_{c1}. FIG. 26 is a graph showing superimposition of the reference histogram 960 and an object histogram 962 after being transferred.

Next, the judgment part 44 obtains an area S₁ (the area of the hatched region in FIG. 26) of an overlapping portion (i.e., common portion) of the reference histogram 960 and the transferred object histogram 962 (Step S2512). Specifically, by using the frequency Nₒ[i] of the reference histogram 960 and the frequency N₁ₛ[i] of the transferred object histogram 962 with respect to the pixel value i, the area S₁ is obtained by the computation of the following equation 4 (Eq. 4).

S₁=Σmin(N₀[i], N₁ₛ[i]) (Eq. 4)

Then, the area S₁ is compared with the threshold value 305 (Step S2513), and it is judged that there is a metal remaining film when the area S₁ is less than the threshold value 305 and that there is no metal remaining film when the area S₁ is not less than the threshold value 305 (Step S2513). Thus, the inspection apparatus 1 uses the above area S₁ as an index value indicating the degree of similarity between the reference histogram and the object histogram.

Further, by using the degree of overlapping of these histograms as the index value through normalization and transfer of the histogram, it is possible to stabilize the relation between the index value and the judgment result and easily perform setting of the threshold value (see FIG. 18, Step S217) in the recipe registration.

When the inspection of one inspection portion 941 is completed, whether there is any uninspected inspection portion 941 or not in the object chip 94 is checked (Step S252), and when there is an uninspected inspection portion 941, Steps S235 to S241 and Step S251 are repeated. Further, when the inspections of all the inspection portions 941 in one object chip 94 are completed, whether there is any uninspected object chip 94 or not is checked (Step S253), and when there is an uninspected object chip 94, Steps S235 to S241 and Step S251 are repeated on all the inspection portions 941 of another object chip 94.

When the inspections of all the inspection portions 941 of all the object chips 94 are completed, a list of the inspection results is displayed on the display 35 (Step S254). The user using the inspection apparatus 1 can select any one of the inspection portions 941 which are judged to have metal remaining films by using the keyboard 36a or the mouse 36b, and through the selection of one inspection portion 941 by the user, the acquired image and the histogram corresponding to the inspection result is displayed on the display 35 (Steps S255 and S256). Through this operation, the user can accurately grasp the state of metal remaining films as a two-dimensional distribution.

When the user grasps the inspection results, the object substrate 9 is unloaded from the stage 121 (Step S257). The object substrate 9 can be automatically loaded and unloaded from/to a substrate processing line, and in this case the inspection apparatus 1 lies “in-line”. The inspection results are transmitted to other apparatuses for processing the chips 94 which are obtained from the unloaded object substrate 9 or inspecting whether the chips 94 are good or not, and used therein. This improves efficiency of processing or inspection in other apparatuses.

The CMP may be performed again on the object substrate 9, depending on the inspection result. This improves the yield of the chips 94 obtained from the object substrate 9 which is processed by insufficient CMP.

Thus, the inspection apparatus 1 can automatically perform the pattern matching of the substrate 9 with high accuracy by using the histograms. Further, since the faulty portions can be accurately grasped as the two-dimensional image in the inspection apparatus 1, it is possible to reduce the load of the user and stably perform the noncontact and nondestructive inspection of a pattern on a semiconductor substrate. Furthermore, by making the intermediate values of the histograms coincident with each other, it is possible to eliminate an ill effect of shift of the pixel value due to the thickness of the thin film and therefore reduce wrong judgments.

Since the histograms are limitedly generated on the inspection area in the imaged area, it is possible to inspect only portions which probably have the metal remaining films with high accuracy.

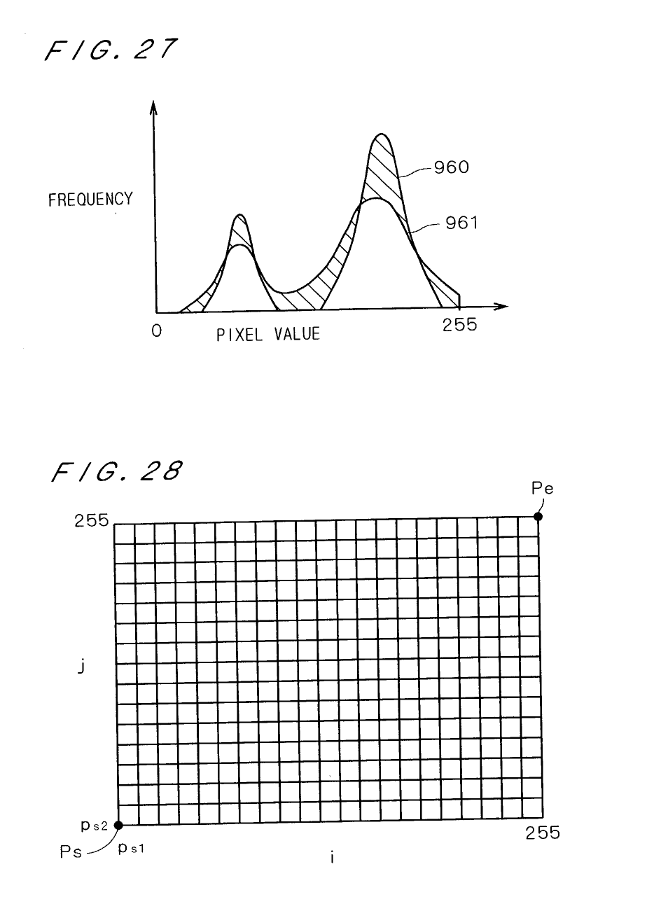

Next, another example of operation of the judgment part 44 using the histograms will be discussed. The easiest index value indicating the degree of similarity between the reference histogram and the object histogram is the distance between these histograms (accumulation of differences in frequency). In a case of the reference histogram 960 and the object histogram 961 as shown FIG. 27, for example, an area S₂ of a hatched region is obtained as an index value by the computation of the following equation 5 (Eq. 5).

S₂=Σabs(N₀[i]−N₁[i]) (Eq. 5)

When the area S₂ is used as the index value, the judgment part 44 judges that there is a metal remaining film when the area S₂ is not less than the threshold value 305 and that there is no metal remaining film when the area S₂ is less than the threshold value 305.

The degree of similarity between the reference histogram and the object histogram may be obtained by dynamic programming on a one-dimensional waveform. When the dynamic programming is used, the histogram has no necessity of being normalized and the histogram of the pixel values in the inspection areas of the reference image and the acquired image can be used. The case of applying the dynamic programming to the reference histogram and the object histogram will be discussed below.

First, the judgment part 44 detects the respective minimum pixel values pₛ₁ and pₛ₂ whose frequency is not zero in the reference histogram and the object histogram. Then, a range of the pixel values from pₛ₁ to 255 and a range of the pixel values from pₛ₂ to 255 are determined as respective path ranges in the dynamic programming. This allows an appropriate judgment even if the distribution of the histogram is one-sided. FIG. 28 is a view showing the path range with the coordinates (pₛ₁, pₛ₂) of a starting point Ps and the coordinates (255, 255) of an end point Pe.

Next, d(i, j) is defined by the following equation 6 (Eq. 6) and a cumulative distance g(i, j) in coordinates (i, j) is defined by the following equation 7 (Eq. 7), where the initial value g(pₛ₁, pₛ₂) is d(pₛ₁, pₛ₂).

d(i,j)=abs(N₀[i]−N₁[j]) (Eq. 6)

g(i,j)=min(g(i−1,j)+d(i,j),

g(i−1,j−1)+2d(i,j),

g(i,j−1)d(i,j)) (Eq. 7)

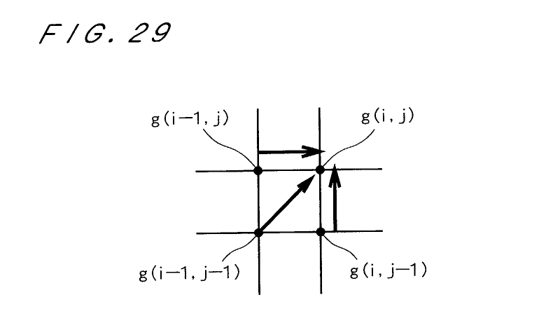

Herein, d(i,j) is the absolute value of difference between the frequency N₀[i] of the pixel value i in the reference histogram and the frequency N₁[j] of the pixel value j in the object histogram, being used as a unit value to be added to the cumulative distance g towards the coordinates (i,j). Eq. 7 represents that d(i,j) is added to the cumulative distance g in horizontal and vertical travels towards the coordinates (i,j) and the addition is performed twice in a diagonal travel, as shown in FIG. 29. The minimum value among three values obtained through these travels is the cumulative distance g(i,j) in the coordinates (i,j).

The judgment part 44 obtains the cumulative distance g(255, 255) at the end point Pe and this cumulative distance is used as the index value. Then, the judgment part 44 judges that there is a metal remaining film when the index value is not less than the threshold value and that there is no metal remaining film when the index value is less than the threshold value. By using the dynamic programming, an inspection with high accuracy can be achieved. Further, as the dynamic programming, other well-known methods may be used.

The present invention is not limited to the above preferred embodiment but allows various variations. For example, the operation shown in FIGS. 12 and 13 allows the following various variations.

In the operation of FIGS. 12 and 13, there may be a case where only the differential image is displayed. Even if whether the pattern is good or not is judged by visual check of the differential image, the load of the user can be reduced as compared with the conventional case where the user performs the inspection with a microscope.

The pixel value of the differential image may be the absolute value of difference in pixel value between the reference image and the acquired image. The method for obtaining the inspection result from the differential image is not limited to the above-discussed method and may be changed as appropriate.

Further, an image obtained by binarization of the difference in pixel value between the reference image and the acquired image with a predetermined threshold value may be used for display and judgment as the differential image. The image after binarization may be processed by contraction and expansion to eliminate noises. Further, binarization may be selectively performed by the user's operation.

The differential image has no necessity of being in a form of differential image data and there may be a case where a value corresponding to the pixel value of the differential image is obtained for every computation. Specifically, by performing the inspection substantially on the basis of the pixel values of the differential image, an appropriate inspection can be achieved.

The edge image may be any image which substantially represents a portion corresponding to the edge. For example, an image which is processed by expansion after a usual extraction of the edge may be used as the edge image.

Though the pixels in the differential image corresponding to the edge area of the edge image are omitted in the computation in the operation of FIGS. 12 and 13, masking with the edge image may be implemented by other methods only if the above pixels are substantially omitted in the computation. There may be a case, for example, where the values of the pixels in the differential image corresponding to the edge area are simply set to 0.

On the other hand, the operation shown in FIGS. 21 and 22 also allows the following various variations. Though one inspection area 942 is determined in one inspection portion 941 in the above case, a plurality of inspection areas 942 may be present in one inspection portion 941.

The inspection area for which the object histogram is generated may be the whole area where the reference image and the acquired image overlap each other. Further, the inspection area may be one of a plurality of areas into which the reference image is divided. In this case, when the corresponding area in the acquired image is less than 60%, for example, the inspection area is omitted from the judgment.

Though the reference histogram is stored in the fixed disk 34 in advance and the judgment part 44 acquires the reference histogram therefrom in the judgment in the operation of FIGS. 21 and 22, the reference histogram may be acquired by calculation at every inspection. Naturally, by obtaining the reference histogram in advance like in the above preferred embodiment, it is possible to reduce the computations performed by the computer 13.

The mechanical structure of the inspection apparatus 1 also allows various variations. In the above preferred embodiment, for example, the stage 121 may travel or rotate after the pattern matching. This allows an inspection with higher accuracy. The optical head part 11 and the stage 121 only have to be relatively movable, and there may be a case, for example, where the optical head part 11 is movable relatively to the stage 121.

Though the selection of the illumination light is performed for each inspection portion 941 in the above preferred embodiment, the kind of illumination light may be fixed for one substrate 9.

The inspection apparatus 1 is not limitedly used for the inspection for remaining films in CMP, but can be widely used for defect inspection of a pattern on a semiconductor substrate.

While the invention has been shown and described in detail, the foregoing description is in all aspects illustrative and not restrictive. It is therefore understood that numerous modifications and variations can be devised without departing from the scope of the invention.

What is claimed is:

1. An apparatus for inspecting a pattern on a semiconductor substrate, comprising:
a lighting part for emitting an illumination light to said semiconductor substrate;
an image pickup device for acquiring data of a two-dimensional image of said pattern on said semiconductor substrate;
an calculation part for performing calculations on said data of said two-dimensional image; and
a storage for storing data of a reference image,
wherein said calculation part establishes correspondence between pixels of said reference image and pixels of said two-dimensional image and obtains the difference in value of corresponding pixels between said reference image and said two-dimensional image to generate data of a differential image.

2. The apparatus according to claim 1, further comprising:
a display for displaying said differential image.

3. The apparatus according to claim 1, wherein
said calculation part obtains an index value indicating the degree of similarity between said reference image and said two-dimensional image on the basis of said differential image and compares said index value with a predetermined threshold value to acquire an inspection result.

4. The apparatus according to claim 3, wherein
said storage stores data of an edge image which is obtained by extracting an edge from said reference image, and
pixels in said differential image which correspond to an edge area indicated by said edge image are substantially omitted in obtaining said index value.

5. The apparatus according to claim 1, wherein
said lighting part emits a monochromatic light as said illumination light.

6. The apparatus according to claim 1, wherein
said lighting part selects one of a plurality of kinds of illumination lights to be emitted to said semiconductor substrate.

7. The apparatus according to claim 1, wherein
said calculation part obtains correlation between said reference image and said two-dimensional image by substantially rotating said two-dimensional image at arbitrary angles relatively to said reference image in establishing correspondence between said pixels of said reference image and said pixels of said two-dimensional image.

8. The apparatus according to claim 1, wherein
said reference image is an image of said semiconductor substrate which is processed by appropriate chemical mechanical polishing.

9. A method of inspecting a pattern on a semiconductor substrate, comprising the steps of:
emitting an illumination light to said semiconductor substrate;
acquiring data of a two-dimensional image of said pattern on said semiconductor substrate;
establishing correspondence between pixels of a reference image which is prepared in advance and pixels of said two-dimensional image;
obtaining the difference in value of corresponding pixels between said reference image and said two-dimensional image to generate data of a differential image; and
obtaining an index value indicating the degree of similarity between said reference image and said two-dimensional image on the basis of said differential image while omitting pixels which correspond to an edge area indicated by an edge image which is prepared in advance, and then comparing said index value with a predetermined threshold value to acquire an inspection result.

10. The method according to claim 9, wherein
one of a plurality of kinds of illumination lights is selected in said step of emitting said illumination light.

11. The method according to claim 9, wherein
correlation between said reference image and said two-dimensional image is obtained by substantially rotating said two-dimensional image at arbitrary angles relatively to said reference image in said step of establishing said correspondence.

12. A computer-readable medium carrying a program for inspecting a semiconductor substrate, wherein execution of said program by a computer causes said computer to perform the steps of:
establishing correspondence between pixels of a reference image which is prepared in advance and pixels of a two-dimensional image which is obtained by imaging said semiconductor substrate;
obtaining the difference in value of corresponding pixels between said reference image and said two-dimensional image to generate data of a differential image; and
obtaining an index value indicating the degree of similarity between said reference image and said two-dimensional image on the basis of said differential image while omitting pixels which correspond to an edge area indicated by an edge image which is prepared in advance, and then comparing said index value with a predetermined threshold value to acquire an inspection result.

13. The computer-readable medium according to claim 12, wherein
correlation between said reference image and said two-dimensional image is obtained by substantially rotating said two-dimensional image at arbitrary angles relatively to said reference image in said step of establishing said correspondence.

14. An apparatus for inspecting a pattern on a semiconductor substrate, comprising:
a lighting part for emitting an illumination light to said semiconductor substrate;
an image pickup device for acquiring data of a two-dimensional image of said pattern on said semiconductor substrate;
an calculation part for performing calculations on said data of said two-dimensional image; and
a storage for storing data of a reference image, wherein said calculation part acquires a first histogram and a second histogram of pixel values in corresponding areas of said reference image and said two-dimensional image, respectively, and obtains an index value indicating the degree of similarity between said first histogram and said second histogram.

15. The apparatus according to claim 14, wherein
said first histogram is stored in said storage in advance.

16. The apparatus according to claim 14, wherein
said calculation part establishes correspondence between pixels of said reference image and pixels of said two-dimensional image.

17. The apparatus according to claim 16, wherein
said calculation part obtains correlation between said reference image and said two-dimensional image by substantially rotating said two-dimensional image at arbitrary angles relatively to said reference image in establishing correspondence between said pixels of said reference image and said pixels of said two-dimensional image.

18. The apparatus according to claim 14, wherein
said calculation part obtains an area of common portion of said first histogram and said second histogram as said index value.

19. The apparatus according to claim 18, wherein
said calculation part equalizes an area of said first histogram and an area of said second histogram in obtaining said index value.

20. The apparatus according to claim 18, wherein
said calculation part changes a relatively positional relation between said first histogram and said second histogram so that the center pixel values of said first histogram and said second histogram coincide in obtaining said index value.

21. The apparatus according to claim 14, wherein
said calculation part obtains said index value by dynamic programming.

22. The apparatus according to claim 14, wherein
said lighting part emits a monochromatic light as said illumination light.

23. The apparatus according to claim 14, wherein
said lighting part selects one of a plurality of kinds of illumination lights to be emitted to said semiconductor substrate.

24. The apparatus according to claim 14, wherein
said reference image is an image of said semiconductor substrate which is processed by appropriate chemical mechanical polishing.

25. A method of inspecting a pattern on a semiconductor substrate, comprising the steps of:
emitting an illumination light to said semiconductor substrate;
acquiring data of a two-dimensional image of said pattern on said semiconductor substrate;
acquiring a first histogram and a second histogram of pixel values in corresponding areas of a reference image which is prepared in advance and said two-dimensional image, respectively; and
obtaining an index value indicating the degree of similarity between said first histogram and said second histogram.

26. The method according to claim 25, further comprising the step of
establishing correspondence between pixels of said reference image and pixels of said two-dimensional image before said step of acquiring said first histogram and said second histogram.

27. The method according to claim 26, wherein
correlation between said reference image and said two-dimensional image is obtained by substantially rotating said two-dimensional image at arbitrary angles relatively to said reference image in said step of establishing said correspondence.

28. The method according to claim 25, wherein
an area of common portion of said first histogram and said second histogram is obtained as said index value.

29. The method according to claim 28, wherein
an area of said first histogram and an area of said second histogram are equalized in said step of obtaining said index value.

30. The method according to claim 28, wherein
a relatively positional relation between said first histogram and said second histogram is changed so that the center pixel values of said first histogram and said second histogram coincide in said step of obtaining said index value.

31. The method according to claim 25, wherein
said index value is obtained by dynamic programming in said step of obtaining said index value.

32. The method according to claim 25, wherein
one of a plurality of kinds of illumination lights is selected in said step of emitting said illumination light.

33. A computer-readable medium carrying a program for inspecting a semiconductor substrate, wherein execution of said program by a computer causes said computer to perform the steps of:
acquiring a first histogram and a second histogram of pixel values in corresponding areas of a reference image which is prepared in advance and a two-dimensional image which is obtained by imaging said semiconductor substrate, respectively; and
obtaining an index value indicating the degree of similarity between said first histogram and said second histogram.

34. The computer-readable medium according to claim 33, wherein execution of said program by said computer further causes said computer to perform the step of
establishing correspondence between pixels of said reference image and pixels of said two-dimensional image before said step of acquiring said first histogram and said second histogram.

35. The computer-readable medium according to claim 34, wherein
correlation between said reference image and said two-dimensional image is obtained by substantially rotating said two-dimensional image at arbitrary angles relatively to said reference image in said step of establishing said correspondence.

36. The computer-readable medium according to claim 33, wherein
an area of common portion of said first histogram and said second histogram is obtained as said index value.

37. The computer-readable medium according to claim 36, wherein
an area of said first histogram and an area of said second histogram are equalized in said step of obtaining said index value.

38. The computer-readable medium according to claim 36, wherein
a relatively positional relation between said first histogram and said second histogram is changed so that the center pixel values of said first histogram and said second histogram coincide in said step of obtaining said index value.

39. The computer-readable medium according to claim 33, wherein
said index value is obtained by dynamic programming in said step of obtaining said index value.
